(19) United States
(12) Patent Application Publication
(10) Pub. No.: US 2008/0205189 A1
(43) Pub. Date: Aug. 28, 2008

(54) DENSE PHASE PUMP FOR PULVERULENT MATERIAL

(75) Inventors: Roger T. Cedoz, Curtice, OH (US); John F. Schaupp, Sylvania, OH (US)

Correspondence Address: BARNES & THORNBURG LLP, 11 SOUTH MERIDIAN, INDIANAPOLIS, IN, 46204, US

(73) Assignee: ILLINOIS TOOL WORKS INC., Glenview, IL (US)

(21) Appl. No.: 11/679,245

(22) Filed: Feb. 27, 2007

(51) Int. Cl. B01F 13/02

(52) U.S. Cl. 366/107; 239/311

(57) ABSTRACT

A vessel for fluidizing bulk pulverulent material to render the pulverulent material flowable for removal from the vessel includes first, second, third and fourth ports. The first port is provided for entry of a fluidizing gas or mixture of gases to the vessel. The second port controls a first stream of fluidizing gas or mixture of gases escaping from the vessel at a relatively constant rate to promote the fluidization of bulk pulverulent material introduced into the vessel. The third port is selectively controlled to vary the rate of escape of a second stream of fluidizing gas or mixture of gases. The fluidized pulverulent material is withdrawn from the vessel through the fourth port at a rate in opposition to the rate of escape of the second stream of fluidizing gas or mixture of gases.

### FIELD OF THE INVENTION

This invention relates to apparatus and methods for the transport of pulverulent materials, hereinafter sometimes referred to as powder. It is disclosed in the context of powders which are used to coat articles. Such powders are hereinafter sometimes described as coating powders, powder coating materials, or similar terms.

### BACKGROUND OF THE INVENTION

Various types of powder coating equipment are known. There are, for example, the systems illustrated and described in the following listed U.S. patents and published applications, and in the prior art cited therein: 2004/0174862; 2005/0207901; 2006/0159565; 2006/0185586; U.S. Pat. Nos. 4,744,701; 5,199,989; 5,215,261; 5,240,185; 5,271,695; 5,323,547; 5,335,828; 5,351,520; 5,473,947; 5,518,344; 5,662,772; 5,690,450; 5,768,800; 5,800,876; 6,432,173; 6,669,780; 6,878,205; and, 6,908,048; in WO 2006/084253, EP 1 454 675 A2 and DE 103 53 968; and in ITW Gema FPP01 Fresh Powder Pump Operating Instructions And Spare Parts List, November 2004. There are also the devices illustrated and described in US 2005/0253101 and ITW Ransburg Electrostatic Systems AIRTRONIC Models: 79053 AirTronic Module A10449-XX Remote AirTronic Assembly, © 2005. The disclosures of all of those references are hereby incorporated herein by reference. This listing is not intended to be representations that a complete search of all relevant art has been made, or that no more pertinent art than that listed exists, or that the listed art is material to patentability. Nor should any such representation be inferred.

### DISCLOSURE OF THE INVENTION

According to an aspect of the invention, a vessel for fluidizing bulk pulverulent material to render the pulverulent material flowable for removal from the vessel includes first, second, third and fourth ports. The first port is provided for entry of a fluidizing gas or mixture of gases to the vessel. The second port permits fluidizing gas or mixture of gases to escape from the vessel at a relatively constant rate to promote fluidization of bulk pulverulent material introduced into the vessel. The third port permits fluidizing gas or mixture of gases to escape from the vessel at a selectively variable rate to cause fluidized pulverulent material to flow from the vessel. The fluidized pulverulent material is withdrawn from the vessel through the fourth port under the control of the third port.

According to another aspect of the invention, a vessel for fluidizing bulk pulverulent material to render the pulverulent material flowable for removal from the vessel includes first, second, third and fourth ports. The first port is provided for entry of a fluidizing gas or mixture of gases to the vessel. The second port controls a first stream of fluidizing gas or mixture of gases escaping from the vessel at a relatively constant rate to promote the fluidization of bulk pulverulent material introduced into the vessel. The third port is selectively controlled to vary the rate of escape of a second stream of fluidizing gas or mixture of gases. The fluidized pulverulent material is withdrawn from the vessel through the fourth port at a rate in opposition to the rate of escape of the second stream of fluidizing gas or mixture of gases.

Illustratively, the vessel further includes a fifth port for introducing pulverulent material to be fluidized into the vessel for fluidization and withdrawal.

Illustratively, the vessel includes a semipermeable membrane having a first side and a second side. The first port is provided on the first side. The second, third and fourth ports are provided on the second side. The second side is adapted for receipt of bulk pulverulent material to be fluidized in the vessel.

Further illustratively, the vessel includes a pulverulent material pickup conduit including a fifth port which lies in the fluidized powder zone of vessel. The fourth port is coupled to the second end of pulverulent material pickup conduit.

Illustratively, a coating system is combined with the vessel. The coating system includes a pulverulent material applicator and a conduit coupling the fourth port to the pulverulent material applicator.

According to another aspect of the invention, a method of operating a vessel for fluidizing bulk pulverulent material to render the pulverulent material flowable for removal from the vessel includes providing on the vessel a first port, supplying a fluidizing gas or mixture of gases to the vessel through the first port, providing on the vessel a second port, permitting fluidizing gas or mixture of gases to escape from the vessel at a relatively constant rate through the second port to promote the fluidization of bulk pulverulent material introduced into the vessel, providing on the vessel a third port, permitting fluidizing gas or mixture of gases to escape from the vessel through the third port at a selectively variable rate, providing on the vessel a fourth port, and withdrawing fluidized pulverulent material from the vessel through the fourth port. Fluidized pulverulent material flows from the vessel through the fourth port in opposition to the selectively variable rate of escape of the fluidizing gas or mixture of gases.

Illustratively according to this aspect of the invention, the method further includes providing on the vessel a fifth port and selectively opening the fifth port and introducing pulverulent material to be fluidized into the vessel for fluidization and withdrawal.

### BRIEF DESCRIPTION OF THE DRAWINGS

The invention may best be understood by referring to the following detailed description and accompanying drawings which illustrate the invention. In the drawings:

FIG. 1 illustrates a block diagram useful in understanding the invention;

FIG. 2 illustrates a partly sectional side elevational view of components of the system illustrated in FIG. 1;

FIG. 3 illustrates a fragmentary, partly longitudinal sectional view of a detail of the system illustrated in FIGS. 1-2; and,

FIG. 4 illustrates a fragmentary longitudinal sectional view of an alternative detail to the detail illustrated in FIG. 3.

### DETAILED DESCRIPTIONS OF THE ILLUSTRATIVE EMBODIMENTS

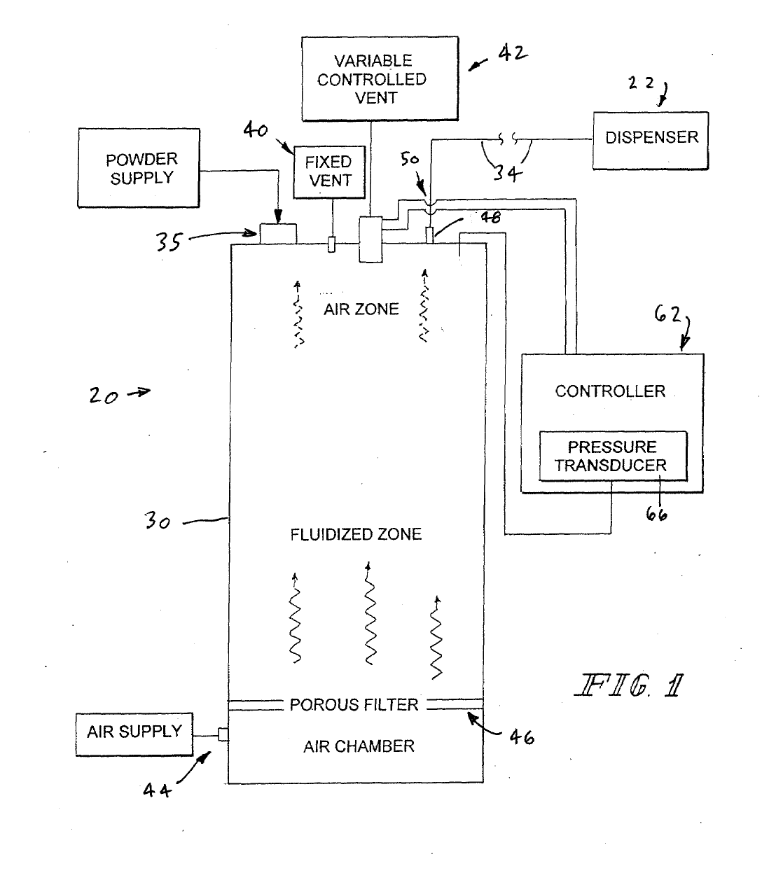

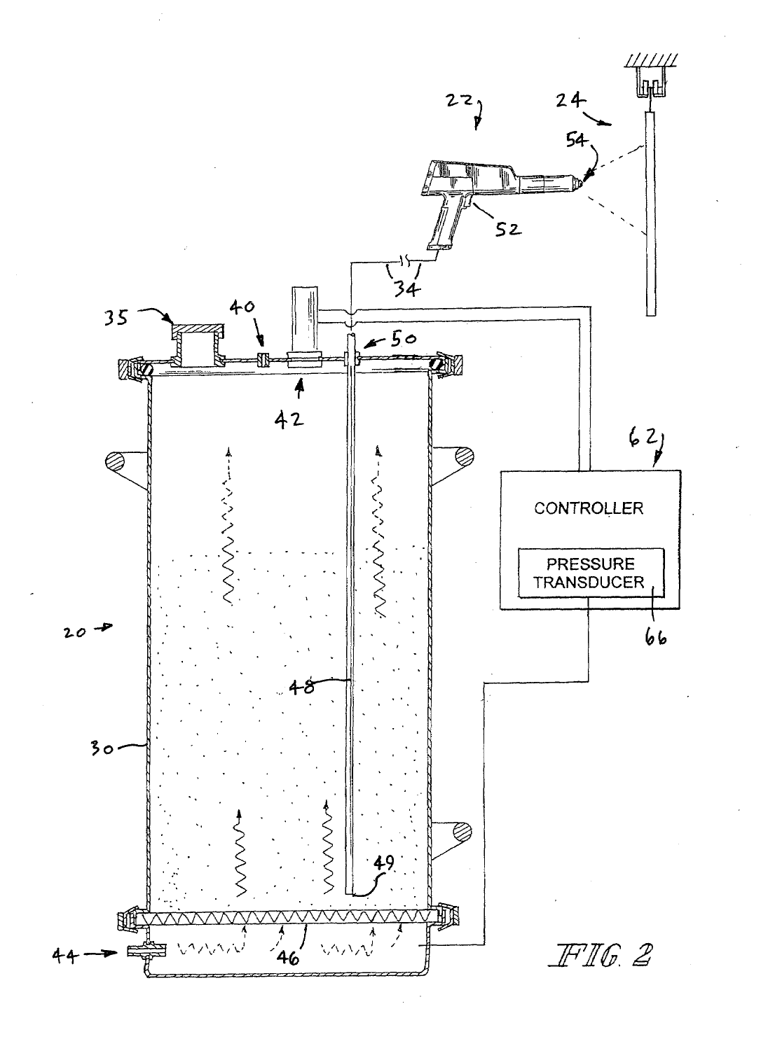

Referring to FIG. 1, a powder coating system 20 includes a powder dispensing device or applicator 22 for atomizing and dispensing a selected powder coating material toward an article 24 (hereinafter sometimes a target) to be coated thereby. See FIG. 2. The powder coating material is typically transported to the applicator 22 on a stream of delivery gas, such as compressed air. The powder is delivered from a pressurized vessel 30, such as a fluidized bed. The powder stream is conveyed through a tube 34 from fluidized bed 30 to the applicator 22. The powder is transported to the applicator 22 nozzle and dispersed as powder particles.

Every effort is made in a powder delivery system 20 to provide a powder particle stream having a consistent output without any pulsation. Care must also be taken in the design, construction and operation of the powder coating system 20 that the powder particles do not drop from the powder stream as they travel from the fluidized bed 30 to the applicator 22. Thus, for example, care is taken in the selection of the tube 34 cross sectional area (which is typically circular) to maintain the speed at which the delivery gas and powder flow fast enough to maintain the powder suspended in the delivery gas flow through the tube 34.

A fluidized bed 30 is used to pump dense phase powder to an applicator 22. The fluidized bed 30 includes powder supply tube 34, a fill port 35 and closure permitting the adding of powder, a fixed vent port 40 and a variable vent port 42. The pressure in the fluidized bed 30 is achieved by having a supply of delivery gas introduced through a delivery gas port 44 under a semipermeable fluidizing membrane 46 of fluidized bed 30. Semipermeable membrane 46 illustratively is (a) sintered resin or polymer material(s) that permits the delivery gas introduced through port 44 to pass through it, but prevents the powder coating material supplied through port 35 from passing through it. Such materials are used, for example, in the fluidizing membranes of coating powder fluidizing beds, such as those illustrated and described in several of the above identified U.S. patents and published applications. Such materials include, for example, the porous plastics available from Atlas Minerals & Chemicals, Inc., P.O. Box 38, 1227 Valley Road, Mertztown, Pa. 19539.

The delivery gas passes through the fluidizing membrane 46, the powder, and is partially vented through the fixed port 40. The delivery gas movement fluidizes the powder in bed 30. The powder is transported through a powder pickup tube 48 (FIG. 2) from an inlet end 49 which lies in the fluidized powder zone of fluidized bed 30 upward through the powder outlet port 50 on fluidized bed 30 when a trigger valve 52 opens. The trigger valve is illustrated as being on the applicator 22. However, it should be understood that it is also not uncommon to mount such trigger valves 52 on the fluidized bed 30 and have them controllable either from the fluidized bed 30 or from the dispensing device 22, or both. In any event, opening trigger valve 52 permits the powder to travel to the output port 54 of the applicator 22 by virtue of the pressure differential between the fluidized bed 30 and the pressure in the environment at the output port 54 of the applicator 22, less any pressure losses in components 34, 48, 22. Powder flow rate is controlled by controlling the pressure inside fluidized bed 30 by venting the internal pressure through fixed vent port 40 and variable vent port 42.

The method and apparatus provide flow control by controlling pressure inside fluidized bed 30 by venting fluidized bed 30 pressure through the fixed vent port 40 and variable vent port 42. Variable vent port 42 illustratively comprises a valve 60 of the type illustrated and described in published US 2005/0253101 controlled from a microprocessor (μP)-based valve controller module 62 which compares the pressure sensed by a pressure transducer 66 to atmospheric pressure to operate a stepper motor 68 associated with the valve 60 in a feedback loop. Valve 42, controller module 62, transducer 66 and stepper motor 68 may all be of the general types illustrated and described in ITW Ransburg Electrostatic Systems AIRTRONIC Models: 79053 AirTronic Module A10449-XX Remote AirTronic Assembly, © 2005. Pressure transducer 66 illustratively monitor the pressure below fluidizing membrane 46, as illustrated in FIG. 1, or the pressure within the powder fluidizing portion of fluidized bed 30, as illustrated in FIG. 2. Actuation of the stepper motor 68 adjusts the valve 60 to modulate the venting of compressed air from fluidized bed 30 as required to maintain the setpoint pressure in fluidized bed 30.

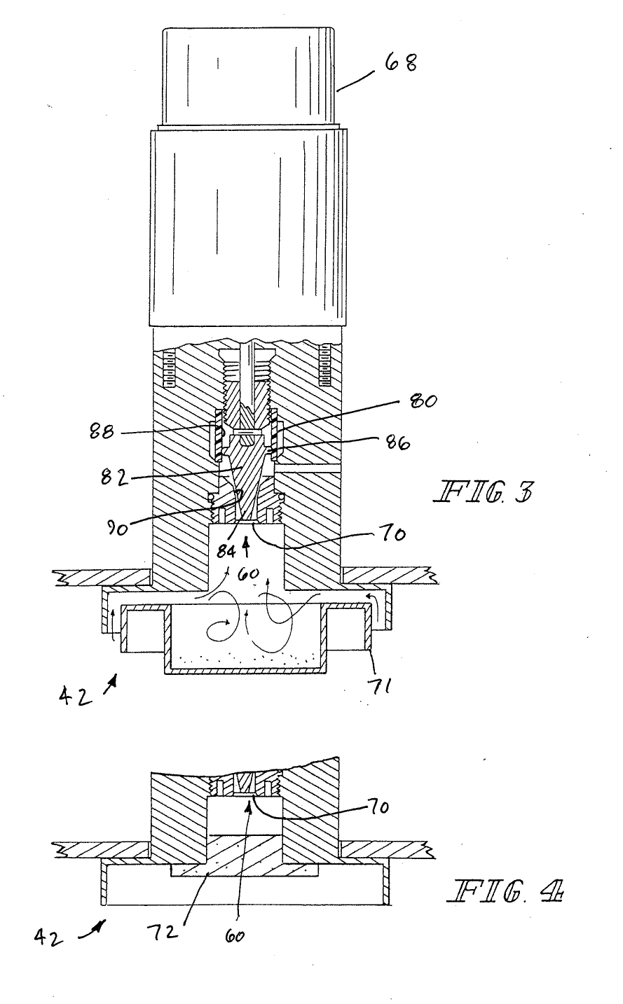

Protection of the entry port 70 of valve 60 may be desired to minimize the entry of powder into valve 60. This can be achieved, for example, with a powder trap 71 of the general configuration illustrated in FIG. 3, or by placing a semipermeable disk 72, for example, a disk of the same material as fluidizing membrane 46, over the entry port 70 of valve 60, as illustrated in FIG. 4. To provide additional protection of valve 60 against the effects of entry of powder through port 70, valve 60 includes an elastomeric sleeve 80 and the head 82 of valve needle 84 includes a wiper collar 86 that scrubs against the inside surface 88 of sleeve 80 as the stepper motor 68 advances and retracts the valve needle 84 toward and away from the seat 90 of valve 60. This scrubbing tends to wipe any accumulated powder from the adjacent surfaces of sleeve 80 and needle 84. The powder then falls back through port 70 into the powder trap 71.

What is claimed is:

1. A vessel for fluidizing bulk pulverulent material to render the pulverulent material flowable for removal from the vessel, the vessel including a first port for entry of a fluidizing gas or mixture of gases to the vessel, a second port permitting fluidizing gas or mixture of gases to escape from the vessel at a relatively constant rate to promote fluidization of bulk pulverulent material introduced into the vessel, a third port permitting fluidizing gas or mixture of gases to escape from the vessel at a selectively variable rate to cause fluidized pulverulent material to flow from the vessel, and a fourth port through which fluidized pulverulent material is withdrawn from the vessel under the control of the third port.

2. The vessel of claim 1 further including a fifth port for introducing pulverulent material to be fluidized into the vessel for fluidization and withdrawal.

3. The vessel of claim 1 further including a semipermeable membrane having a first side and a second side, the first port provided on the first side, the second, third and fourth ports provided on the second side, and the second side adapted for receipt of bulk pulverulent material to be fluidized in the vessel.

4. The vessel of claim 3 further including a pulverulent material pickup conduit including a fifth port which lies in the fluidized powder zone of vessel, the fourth port being coupled to the second end of pulverulent material pickup conduit.

5. In combination with the vessel of claim 1, a coating system including a pulverulent material applicator and a conduit coupling the fourth port to the pulverulent material applicator.

6. A vessel for fluidizing bulk pulverulent material to render the pulverulent material flowable for removal from the vessel, the vessel including a first port for entry of a fluidizing gas or mixture of gases to the vessel, a second port controlling a first stream of fluidizing gas or mixture of gases escaping from the vessel at a relatively constant rate to promote the fluidization of bulk pulverulent material introduced into the vessel, a third port for selectively controlling a second stream of fluidizing gas or mixture of gases escaping from the vessel at a selectively variable rate, and a fourth port through which fluidized pulverulent material is withdrawn from the vessel under the control of the third port, fluidized pulverulent material flowing from the vessel in opposition to the rate of escape of the second stream of fluidizing gas or mixture of gases.

7. The vessel of claim 6 further including a fifth port for introducing pulverulent material to be fluidized into the vessel for fluidization and withdrawal.

8. The vessel of claim 6 further including a semipermeable membrane having a first side and a second side, the first port provided on the first side, the second, third and fourth ports provided on the second side, and the second side adapted for receipt of bulk pulverulent material to be fluidized in the vessel.

9. The vessel of claim 7 further including a pulverulent material pickup conduit including a fifth port which lies in a fluidized powder zone of vessel, the fourth port being coupled to the second end of pulverulent material pickup conduit.

10. In combination with the vessel of claim 6, a coating system including a pulverulent material applicator and a conduit coupling the fourth port to the pulverulent material applicator.

11. A method of operating a vessel for fluidizing bulk pulverulent material to render the pulverulent material flowable for removal from the vessel, the method including providing on the vessel a first port, supplying a fluidizing gas or mixture of gases to the vessel through the first port, providing on the vessel a second port, permitting fluidizing gas or mixture of gases to escape from the vessel at a relatively constant rate through the second port to promote the fluidization of bulk pulverulent material introduced into the vessel, providing on the vessel a third port, permitting fluidizing gas or mixture of gases to escape from the vessel through the third port at a selectively variable rate, providing on the vessel a fourth port, and withdrawing fluidized pulverulent material from the vessel through the fourth port, fluidized pulverulent material flowing from the vessel through the fourth port in opposition to the selectively variable rate of escape of the fluidizing gas or mixture of gases.

12. The vessel of claim 11 further including providing on the vessel a fifth port and selectively opening the fifth port and introducing pulverulent material to be fluidized into the vessel for fluidization and withdrawal.
